(19) United States
(12) Patent Application Publication
(10) Pub. No.: US 2014/0105545 A1
(43) Pub. Date: Apr. 17, 2014

(54) GRADED COMPOSITION FOR OPTICAL WAVEGUIDE FERRULE

(71) Applicant: Corning Cable Systems LLC, Hickory, NC (US)

(72) Inventors: Jeffrey Dean Danley, Hickory, NC (US); Robert Bruce Elkins, II, Hickory, NC (US); Thomas Dale Ketcham, Horseheads, NY (US); Robert Michael Morens, Lindley, NY (US)

(21) Appl. No.: 13/790,440

(22) Filed: Mar. 8, 2013

Related U.S. Application Data
(60) Provisional application No. 61/713,815, filed on Oct. 15, 2012.

(51) Int. Cl. G02B 6/36

(52) U.S. Cl. CPC G02B 6/36
USPC 385/78

(57) ABSTRACT

A ferrule for optical waveguides includes an exterior and an interior of the ferrule. The interior of the ferrule has a bore defined therein that is configured to receive an optical waveguide. Material of the ferrule is such that the material changes from the interior to the exterior of the ferrule, where the thermal expansion coefficient of the material transitions from less than 30×10−7/° C. at the interior of the ferrule to greater than 70×10−7/° C. at the exterior of the ferrule. The thermal expansion coefficient of the material may change by way of discrete layers in the material between the interior and exterior of the ferrule.

### RELATED APPLICATIONS

This application claims the benefit of priority under 35 U.S.C. §119 of U.S. Provisional Application Ser. No. 61/713,815 filed on Oct. 15, 2012, the content of which is relied upon and incorporated herein by reference in its entirety.

### BACKGROUND

Aspects of the present disclosure relate generally to a ferrule system for a fiber optic connector, and methods of manufacturing and using the same.

Typical practice for manufacture of optical fibers attached to hardened ferrules includes attachment of a stripped fiber using epoxy to a hardened ferrule. The fiber is mechanically- or laser-cleaved, and then the end of the fiber and ferrule are polished semi-manually, which can be tedious and expensive. To speed manufacturing it is desired to be able to use lasers, particularly an industrial CO₂ laser, to cleave and polish the optical fiber and ferrule. However, Applicants have found that using an industrialized CO₂ laser, at the intensity, pulse repetition, sweep speed, polarization etc. that would be useful to cleave and machine the optical fiber, can induce fractures in the ferrule. A need exists for a ferrule system that facilitates use of a high-powered laser to cleave and machine, without substantially damaging the ferrule.

### SUMMARY

Technology disclosed herein includes compositions, geometry of compositions, and processes for a ferrule that allows for laser machining of the ferrule, without ferrule damage, while retaining good mechanical properties of the ferrule.

At least one embodiment relates to a glass plus ceramic body that has a low-expansion glass graded to a higher-expansion ceramic/glass. The ferrule is not damaged by laser interaction with an interior, low-expansion material when an optical waveguide and the ferrule surface are being machined. At the same time, ferrule is mechanical reliable, meaning that the ferrule can be connected and disconnected many times in extreme environmental conditions. Technology disclosed herein allows rapid machining and polishing of the ferrule and/or waveguide(s) for the manufacture of optical cables, cable assemblies, and fiber optic connectors.

Technology disclosed herein allows for laser machinability of a low-thermal-expansion-coefficient interior, such as silica with thermal expansion coefficient being approximately 0.55×10⁻⁶/° C., along with a tough, damage-resistant exterior, such as zirconia with thermal expansion coefficient being approximately 11.5-12×10⁻⁶/° C. The thermal expansion coefficient of the ferrule, between the interior and exterior, is graded or layered to lower maximum stresses and stress transfer between layers. Further, in some embodiments, waveguide and/or ferrule machining can be automated using high-powered, fast-heating lasers without cracking the ferrule, resulting in cost savings, connectorization speed increases, and more accurate machining tolerances.

Additional features and advantages are set forth in the Detailed Description that follows, and in part will be readily apparent to those skilled in the art from the description or recognized by practicing the embodiments as described in the written description and claims hereof, as well as the appended drawings. It is to be understood that both the foregoing general description and the following Detailed Description are merely exemplary, and are intended to provide an overview or framework to understand the nature and character of the claims.

### BRIEF DESCRIPTION OF THE FIGURES

The accompanying Figures are included to provide a further understanding, and are incorporated in and constitute a part of this specification. The drawings illustrate one or more embodiments, and together with the Detailed Description serve to explain principles and operations of the various embodiments. As such, the disclosure will become more fully understood from the following Detailed Description, taken in conjunction with the accompanying Figures, in which:

FIG. 1 is a schematic diagram of ferrule in cross-section according to an exemplary embodiment.

FIG. 2 is a scanning electron microscope (SEM) micrograph of four sintered layers with a composition gradient according to an exemplary embodiment.

FIG. 3 is an SEM micrograph of a silica rod in a material including 50% glass and 50% glass-ceramic according to an exemplary embodiment.

FIGS. 4-5 are plots of estimated macro-stresses in five-layer ferrules according to exemplary embodiments.

FIGS. 6-7 are plots of estimated macro-stresses in two-layer ferrules.

FIGS. 8-16 are SEM micrographs showing material microstructure according to exemplary embodiments.

FIG. 17 is a schematic diagram of multi-fiber ferrule in cross-section according to an exemplary embodiment.

### DETAILED DESCRIPTION

Before turning to the following Detailed Description and Figures, which illustrate exemplary embodiments in detail, it should be understood that the present disclosure is not limited to the details or methodology set forth in the Detailed Description or illustrated in the Figures. For example, as will be understood by those of ordinary skill in the art, features and attributes associated with embodiments shown in one of the Figures or described in the text relating to one of the embodiments may well be applied to other embodiments shown in another of the Figures or described elsewhere in the text.

Referring to FIG. 1, a ferrule 110 includes an interior defining a bore 112 configured to receive a waveguide, such as an optical fiber 114. According to an exemplary embodiment, the ferrule 110 is graded or layered. The interior 116 of the graded or layered ferrule includes a low-expansion material, such as a material having a coefficient of thermal expansion that is less than 40×10⁻⁷/° C., preferably less than 30×10⁻⁷/° C. In some embodiments, the interior 116 includes a boro-silicate or silica glass, preferably a silica glass. In some such embodiments, the interior 116 has an outer diameter 118 that is greater than 200 microns; but, in some embodiments, is less than 2.3 mm in diameter, preferably a diameter between 300 microns and 1 mm, more preferably between 300 microns and 600 microns.

According to an exemplary embodiment, the ferrule 110 has an outer region 120 and/or layer (e.g., exterior 122 of the ferrule 110) that includes a ceramic plus glass. In some such embodiments, the ceramic includes zirconia, preferably tetragonal zirconia with the ceramic being more than 40 volume percentage of the composition of the exterior 122 of the ferrule 110.

According to an exemplary embodiment, the interior 116 of the ferrule may be a redrawn glass rod (e.g., silica rod) with an inner-diameter bore 112 (e.g., hole) of about 120-130 microns in cross-sectional diameter. In some embodiments, one end is tapered (not shown) from the outer diameter of the silica rod to the inner hole, which may ease insertion of the optical fiber 114.

According to an exemplary embodiment, the ferrule 110 is graded between the interior 116 and exterior 122. In some embodiments, a second layer 126 of the ferrule 110 adjoining the interior 116 of the ferrule 110 may include a layer of low-expansion glass, glass/ceramic, or glass plus ceramic. The second layer 126 has a higher coefficient of thermal expansion than the low-expansion inner core (i.e., interior 116). According to an exemplary embodiment, the ferrule 110 includes a third layer 128 of glass, glass/ceramic, or glass plus ceramic having a coefficient of thermal expansion that is greater than the second layer 126. In some embodiments, the ferrule 110 may further include a fourth layer 130 of higher-expansion glass, glass/ceramic, or glass plus ceramic; and a fifth and outer layer 120 of still higher expansion glass/ceramic or glass plus ceramic.

In some embodiments, a ferrule 110 for optical waveguides includes a glass plus crystalline ceramic, where the thermal expansion coefficient is graded in layers or continuously changes. In some such embodiments, the thermal expansion coefficient changes from less than 7×10⁻⁷/° C. for material on the interior 116 of the ferrule 110 to greater than 90×10⁻⁷/° C. for material on the exterior 122 of the ferrule 110. The thermal expansion coefficient for layers 116, 126, 128, 130, 120 of the ferrule 110 may increase in incrementally greater amounts with distance from the interior 116 of the ferrule 110, or the thermal expansion coefficient material may continuously, and smoothly increase with distance from the interior 116. In other embodiments, some intermediate layers or sections may contrast the general trend, temporarily decreasing in coefficient of expansion or staying the same with respect to distance from the interior 116 of the ferrule 110. Such layers or sections, for example, may serve other functions for the ferrule, such as to facilitate laser light transmission or provide thermal barriers with respect to heat transfer.

Applicants have generally found that the larger the grading layer or intermediate expansion layer, the less stress there is in the body of the ferrule 110. In some embodiments, the interior 116 of the ferrule 110 is silica, the exterior 122 is at least 40% crystalline zirconia, and an intermediate expansion grading or layer 126 is positioned therebetween. The intermediate expansion 126 grading or layer may be greater than 20 microns thick, such as at least 100 microns. In other such embodiments, the ferrule 110 includes a boro-silicate. In still other embodiments, the glass in the intermediate grading or intermediate layer 126 includes a glass of (in mole %) 59.08 SiO₂, 13.33 B₂O₃, 9.37 Al₂O₃, 8.03 Na₂O, 4.09 CaO, 1.28 Li₂O, 1.64 K₂O, 1.79 MgO, 1.37 ZrO₂.

In some embodiments, material of the exterior 122 is greater than 40% crystalline zirconia and also includes a glass of (in mole %) 59.08 SiO₂, 13.33 B₂O₃, 9.37 Al₂O₃, 8.03 Na₂O, 4.09 CaO, 1.28 Li₂O, 1.64 K₂O, 1.79 MgO, 1.37 ZrO₂. According to at least one embodiment, the grading or layer 126 of the ferrule 110 is over more than 20 microns in thickness and is located next to the interior low-expansion core (i.e., interior 116) is comprised of 25% or more of a glass or glass-ceramic, such as including at least one the families of Glass B (mole %): 60.0 SiO2, 20.0 Al2O3, 20.0 ZnO and Glass C (mole %): 59.0 SiO2, 19.6 Al2O3, 12.4 ZnO, 6.8 Li2O, 2.2 ZrO2.

In some embodiments, the interior 116 of the ferrule 110 is formed by a low-expansion core that is at least 200 microns in outer diameter 118. In some such embodiments, the core is at least 300 microns in outer diameter 118. In some embodiments, crystalline ceramic material is in the exterior 122 of the ferrule 110. In some of those embodiment, the crystalline ceramic material includes zirconia, preferably zirconia that is mainly tetragonal. The zirconia may be doped with a rare earth oxide, Y, Ca, Mg, In, or Sc oxides and combinations thereof. The zirconia may also contain stabilizing dopant aids of oxides of Ti or Sn and/or toughening agents of oxides of Nb, Ta, W, and Mo. Some embodiments include a layered or graded ferrule 110 where crystalline ceramic of the exterior 122 is zirconia with 3 mole % or less yttria, with the zirconia having less than 2.5 mole % yttria being more preferred.

Although some of the examples below use cold pressing as a shape forming method, there are a great variety of methods that can be used for forming the graded or layered body. One of the most useful of such methods includes pressure-less sintering. To reduce stresses developed by the thermal expansion differences of materials of the ferrule 110, Applicants have generally found that the lower the fabrication (sintering) temperature, the better. For example, a process where ferrules are sintered at less than 1100° C. are preferred, with less than 1000° C. being more preferred, with 950° C. being even more preferred, with 850° C. being still more preferred.

In some contemplated embodiments, layered or graded structures of a ferrule 110 as disclosed herein may be formed directly form graded or layered powders. When sintering a pure silica core, according to an exemplary embodiment, temperatures over 1400° C. may be used. However, such temperatures may cause de-vitrification issues with some composition combinations used for the intermediate layers 130, 128, 126. As such, it is preferred to sinter the ferrule 110 around a pre-formed low-expansion core rod (e.g., inner layer 116) having a central bore 112 hole. The central core rod may be redrawn with an accurate central bore if the low expansion core is a glass. Applicants have found that silica and boro-silicates are particularly amenable to this re-draw process.

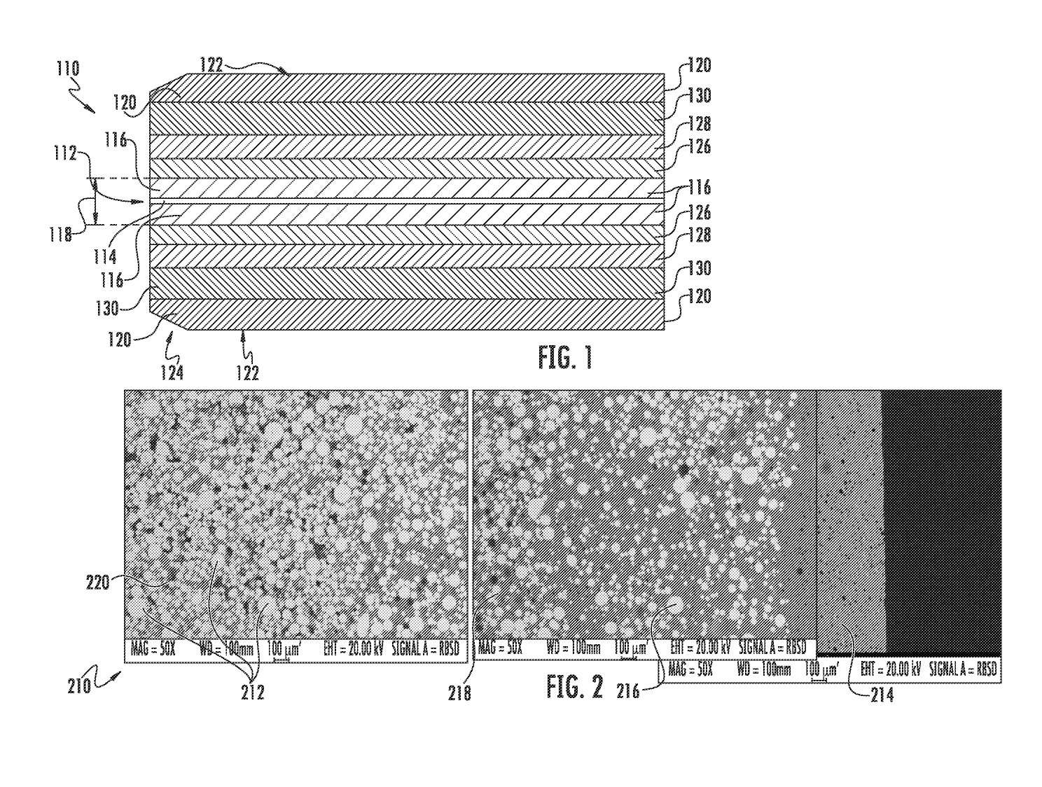

For ease of processing, the crystalline ceramic powders can be used in the form of agglomerates (see agglomerates 212 as shown in FIG. 2), such as may be produced via a spray drying process. With some crystalline ceramic compositions, Applicants have found improved performance by pre-sintering the agglomerates, particles, grains etc. (prior to sintering the ferrule 110) to achieve the desired grain size for the properties of interest. For instance pre-sintering zirconia agglomerates in temperatures between 1250 and 1700° C., preferably between 1300 and 1600 C, may provide near-spherical granules that are nearly pore free, with mostly tetragonal phase zirconia. For example, with such a process, the grains size is large enough to allow some transformation to monoclinic zirconia, allowing the possibility of some transformation toughening.

According to another exemplary embodiment, if a low-expansion core cane (e.g., interior 116) is being made by redraw, layers 126, 128, 130 may be added and/or gradient may be provided using coating cups, drying regions, and/or sintering regions on the end of the draw, in a manner similar to applying a protective polymer coating to optical waveguides. In some such embodiments, there can be a coating cup and drying station for each layer, and if the layer composition can sinter rapidly, Applicants contemplate two or more coating stations with drying and sintering regions, where the rod or cane is drawn through continuously.

According to an exemplary embodiment, extrusion is may be a particularly useful shape forming method for elongate objects, such as those with constant cross-sections. Ram extrusion using a billet of material, where the billet contains the composition gradient or the differing composition layers, may be used to form the complete unfired ferrule body or a graded or layered tube where a core rod of low expansion glass is also used, preferably inserted prior to sintering.

According to some such embodiments, co-extrusion, using more than two feed streams, may be utilized and can give better results than billet/ram extrusion. For example, the entire structure may be co-extruded or several layers can be co-extruded and a dense core rod inserted therein. In some alternate embodiments, tubes of various diameters and compositions can be extruded singly, assembled into layered/graded rods or tubes, perhaps with a pressing operation after assembly to insure knitted interfaces.

According to other embodiments, cold-pressing, uniaxial, dry bag quasi-iso-static, wet bag iso-static methods may be used for forming the ferrule 110. For a dry wet bag or even a uniaxial pressing operation, Applicants contemplate a series of concentric funnels that can fill the bag or die simultaneously, and then have only one pressing operation for the ferrule 110. As shown in the examples below, powders may be pressed and sintered around a dense core rod. Repeated pressing operations are contemplated, with a new composition being built up around the interior body to create layers and gradients. Such pressing operations may be done around a dense core rod, but need not be limited to concentric cylinders of differing compositions and/or thermal expansion coefficients. Assembly of a graded or layered tube around a glass core may be done via a second pressing operation to increase contact between the core and the powder tube. With some such methods too, tubes of various diameters and compositions can be pressed singly, assembled into layered/graded rods or tubes, perhaps with a pressing operation after assembly to insure knitted interfaces.

In some contemplated embodiments, the graded or layered ferrule 110 has a significant amount of glass in some or all areas of the ferrule 110, and does not include a separate central core of glass. Further, Applicants contemplate adjusting the viscosity/composition of the glass (via material selection) to give similar viscosities for the various glass, glass-ceramic, glass plus ceramic layers or gradient, and then building a large graded or layered blank and re-drawing all or part of the ferrule structure. Redrawing a tube may require careful control of the pressure or vacuum in the central bore hole during the re-draw process.

In other contemplated embodiments, electrostatic methods are used for providing graded or layered rod shapes. For example, dry or wet powder can be electrically charged, strong thin gatherer wire filament may be oppositely charged, or a core cane/rod can be coated to make the core cane/rod slightly conductive, and a layered or graded ferrule pre-form can be made. Hollow graded or layered tubes can be made and assembled around an interior glass core. The core rod can be drawn continuously through different powder chambers or different powders may be introduced to a single chamber. For example, metallic pre-forms with a plethora of rod “gatherer” shapes can be used.

In some contemplated embodiments, slip casting methods can be used for graded or layered rod shapes. Powder can be dispersed in a fluid usually via surfactants and suitable salt, acid, base adjustment to the carrier fluid, and the powder deposited in a porous mold. The layered or graded ferrule pre form can be made by sequential removal then additions of fluids with differing powder compositions. A fluid can be delivered to the mold via a tube and the composition of the fluid and powder in the tube varied with time. Hollow graded or layered tubes can be made and assembled around an interior glass core. Pressure slip casting can also be practiced.

In still other contemplated embodiments, electrophoretic methods may be used to provide graded or layered rod shapes. For example, powder can be electrically charged, usually via surfactants and suitable salt, acid, base adjustment to the carrier fluid; and the powder may then be deposited on a strong thin gatherer wire filament oppositely charged, or a core cane/rod coated to make the core cane/rod at least slightly conductive, and layered or graded ferrule pre-form can be made. Hollow graded or layered tubes can be made and assembled around an interior glass core. The core rod can be drawn continuously through different fluid chambers or different powders/fluids may be introduced to a single chamber. Metallic pre-forms with a plethora of rod “gatherer” shapes can be used.

Single-composition ferrules are typically made by injection molding, sintering, and machining Applicants contemplate injection molding a core powder, then sequentially taking the part and putting the part into larger and larger dies, and thereby injection molding more layers around the original core. To maintain the sample of the first core (e.g., interior 116) and layers 126, 128, 130, each succeeding layer may need a lower temperature carrier polymer.

For at least some of the layers, such as the outer crystalline ceramic containing layers 120 or layers forming the gradient, layers or regions with a porosity or a porosity and composition gradient/layers can be arranged as a pre-form and then infiltrated with glass. The infiltration can be driven via capillary forces, or an external pressure can be used. Additionally, the ferrule pre-form may be covered with a gas impermeable glass, and hot iso-static presses may be used.

According to an exemplary embodiment, a combined technique of pull-trusion with either a billet or multiple feed die can be utilized. With a strong core rod, the rod may be mounted on a reel, the real put into a pressure vessel, and the interior rod fed into a billet or multi-feed die and/or extrusion feed pressure chamber, with a seal between the reel pressure chamber and the extrusion feed chamber. With pressures in the two chambers balanced, the core rod may be pulled through an extrusion die while the layered or graded ferrule powder is extruded onto it. A gas or hydraulic pressure can be fed into the reel pressure chamber to prevent hydraulic pressure to prevent extrusion batch back flow.

Another extrusion method includes use a carousel form to hold a core cane or inner core region, and a tube of one layer extruded onto the inner core or rod. Upon heating and/or drying, the outside tube and/or layer will shrink; and part or even the entire carousel may be moved to a second extruder where another, larger layer can be extruded over the previous material. This sequence may be repeated until the final gradation and/or number of layers is finished.

According to another exemplary embodiment, a layered and gradient composition for ferrules 110 may be made by a repeated-dipping method (conceptually similar to 17th century candle making processes). For example, using a thin “bait” fiber or a core rod, and repeatedly dipping the same into a molten slurry of powder and polymer, the layers or gradient is constructed. To maintain the sample of the first core and layers, each succeeding layer may have a lower temperature carrier polymer.

The following examples are provided for context. In some cases, examples below have porosity in layers 126, 128, 130 of the ferrule 110 materials. For strength reasons, and for mechanical reliability and wear concerns, the exterior surface 122 and/or region 120 of the ferrule 110 has the fewest (i.e., a minimum of) large pores relative to the rest of the ferrule 110, which can be controlled through use of binders and plasticizers to achieve better powder packing in some of the above-disclosed processes and to achieve better grading of the size distribution of the powders, and through use of bi- and tri-modal powders, where Applicants have generally found that the smaller powders “fit” into the interstices of the larger powders. Further, porosity can be reduced by hot iso-static pressing. The hot isostatic pressing may work particularly well when the temperature of the pressing is near that of the sintering, such as within 200° C. When the ferrule 110 is sintered to a closed porosity, the ferrule material itself may support the pressure to remove the porosity. The sintering and pressing can be done in a single thermal cycle with a hot iso-pressing furnace. If there is open porosity in the ferrule, then the surface should be made gas impermeable to densify the ferrule 110, which can be accomplished by providing a dense outer coating of glass or metal. For example, in the 700 to 1300° C. range, some ferrous metals are applicable and can be acquired in thin sheets. Numerous ferrules or a long length of numerous ferrules can be spaced on a sheet of material (perhaps with depression for the ferrules), with a second sheet layered on top and sealed, with the air being evacuated. The ferrules or multi ferrule rods can then be hot iso-statically pressed. Pressures at or below 30 kpsi are preferred and cycle times of less than 12 hours are preferred.

### EXAMPLES

Three different zirconia composition were used and three different glass, glass-ceramic compositions where used. The zirconia was purchased from Tosoh Chemical Company, Japan and were TZ 0Y, zirconia without any dopant; TZ2Y, zirconia-2 mole % yttria; and TZ3Y, zirconia with 3 mole % yttria. A medium thermal-expansion (e.g., about 70×10⁻⁷±20×10⁻⁷/° C. expansion coefficient), low-temperature sintering glass, glass A (mole %): 59.08 SiO₂, 13.33 B₂O₃, 9.37 Al₂O₃, 8.03 Na₂O, 4.09 CaO, 1.28 Li₂O, 1.64 K₂O, 1.79 MgO, 1.37 ZrO₂ and two low-expansion, glass-ceramics (e.g., having an approximately 0 to 10×10⁻⁷/° C. expansion coefficient), Glass B (mole %): 60.0 SiO₂, 20.0 Al₂O₃, 20.0 ZnO and Glass C (mole %): 59.0 SiO₂, 19.6 Al₂O₃, 12.4 ZnO, 6.8 Li₂O, 2.2 ZrO₂ were used. Silica “rods” of about 350-400 microns in diameter and 5.5×10⁻⁷/° C. expansion coefficient were also used. The silica “rods” were made by re-drawing a silica boule and can be made with an accurate inner diameter (bore) of about 126 micron.

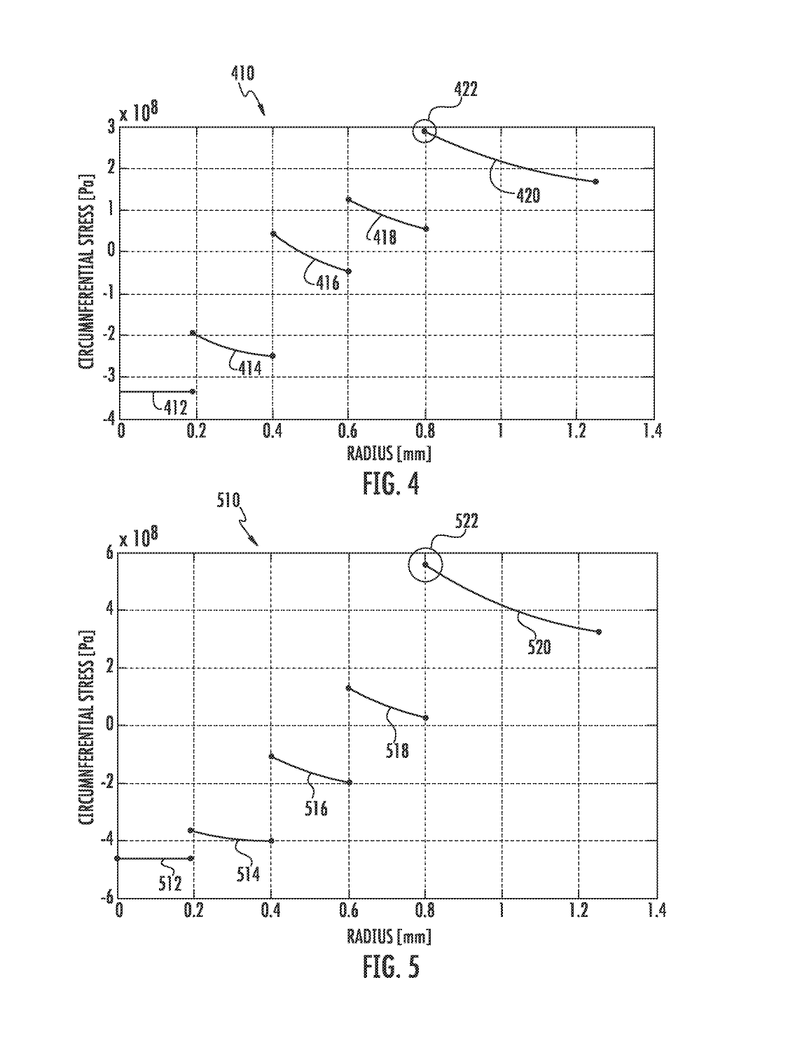

As a guide for experimentation Applicants developed a simple semi-analytic stress model for two- to five-layer structures of infinite-length, cylindrical, elastic structures with the outer layer being about 2.5 mm in outer diameter, as shown in FIGS. 4-7. The model focused on the circumferential (tensile) stress component and allowed for different thermal expansion coefficients, Young's elastic moduli, Poisson's ratios, and layer numbers and thicknesses. All the layers were assumed to be hollow cylinders, except for the inner layer which was a solid cylinder, and all the cylinders were concentric.

Referring once more to FIG. 1, a five-layer ferrule 110 includes a silica interior 116, a layer of a low-expansion glass (e.g., silica core; lower thermal expansion coefficient than the other layers); a layer of glass-ceramic 126 next to the silica core 116; an intermediate thermal expansion coefficient layer of glass 128, a higher thermal expansion glass plus zirconia layer 130, and a higher-still expansion layer 120 of glass plus zirconia. According to an exemplary embodiment, the ferrule 110 includes more than two layers, where each of the layers is formed from a material having a higher coefficient of thermal expansion than the adjacent interior layer, and where the material of the innermost layer 116 has the lowest coefficient of thermal expansion.

### Example 1

Glass A was melted then ground and milled into powder, with the median powder particle size being between 3 to 7 microns; where Glass A is a low-temperature sintering glass, including (mole %): 59.08 SiO₂, 13.33 B₂O₃, 9.37 Al₂O₃, 8.03 Na₂O, 4.09 CaO, 1.28 Li₂O, 1.64 K₂O, 1.79 MgO, 1.37 ZrO₂. Agglomerates of zirconia-3 mole % yttria where pre-sintered at 1300° C. in air for 2 hours. Mixed compositions of zirconia-3 mole % yttria pre-sintered agglomerates were mixed with 50 volume %, 62.5 volume %, and 75 volume % Glass A.

Thin layers of 100% Glass A, 75% Glass A, 62.5% Glass A, and 50% Glass A were spread in a steel bar die and uni-axially pressed. The bar pre-form was placed in a latex iso-pressing bag, the air was removed by a vacuum pump and the bag was sealed. The bar was cold iso-statically pressed to about 25 kpsi. The pressed bar was placed on coarse alumina “setter” sand in an alumina sagger box and sintered at 900° C. in air for 4 hours.

The bar was cut, polished, and examined by scanning electron microscope SEM. FIG. 2 shows the cross-section structure, with the bar intact. More specifically, FIG. 2 shows a SEM micrograph of four sintered layers 214, 216, 218, 220.

### Example 2

Glass-ceramic B was melted then ground and milled into powder, with the median powder particle size being between 3 to 7 microns; where Glass B includes (mole %): 60.0 SiO₂, 20.0 Al₂O₃, 20.0 ZnO. Agglomerates 212 of zirconia-3 mole % yttria where pre sintered at 1550° C. in air for 2 hours. Mixed compositions of zirconia-3 mole % yttria pre sintered agglomerates 212 were mixed with 50 volume % and 75 volume % Glass A. Further, Glass A and glass-ceramic B (i.e., Glass B) were mixed in a 50-50% ratio.

Thin layers of the mixture of 50% Glass A and 50% glass-ceramic B, 100% Glass A, 75% Glass A and 25% zirconia 3 mole % yttria, and 50% glass (e.g., Glass A) plus 50% zirconia-3 mole % yttria were spread in a steel bar die and uni-axially pressed. The bar pre-form was placed in a latex iso-pressing bag, air was removed by a vacuum pump, and the bag was sealed. The bar was cold iso-statically pressed to about 25 kpsi.

The pressed bars were placed on coarse alumina “setter” sand in an alumina sagger box and sintered at 800° C. or 900° C. in air for 4 hours. The bars were intact and graded from a low-expansion glass ceramic of between about 3×10⁻⁶ to 4×10⁻⁶/° C. to a high-expansion glass plus ceramic of about 9.5×10⁻⁶/° C., where the bars across this gradient were intact.

### Example 3

Glass A and glass-ceramic B where mixed in a 50-50% ratio. A layer of the mixture of 50% glass A and 50% glass-ceramic B was spread in a steel bar die, a cleaned silica “rod” of between about 350-400 microns in diameter was placed in the die and a second layer of powder was placed on top and uni-axially pressed. The bar pre-form was placed in a latex iso-pressing bag, the air was removed by a vacuum pump, and the bag was sealed. The bar was cold iso-statically pressed to about 25 kpsi. The pressed bar was placed on coarse alumina “setter” sand in an alumina sagger box and sintered at about 800° C. or 900° C. in air for 4 hours. The bars were intact cross-sectioned and polished and examined by SEM.

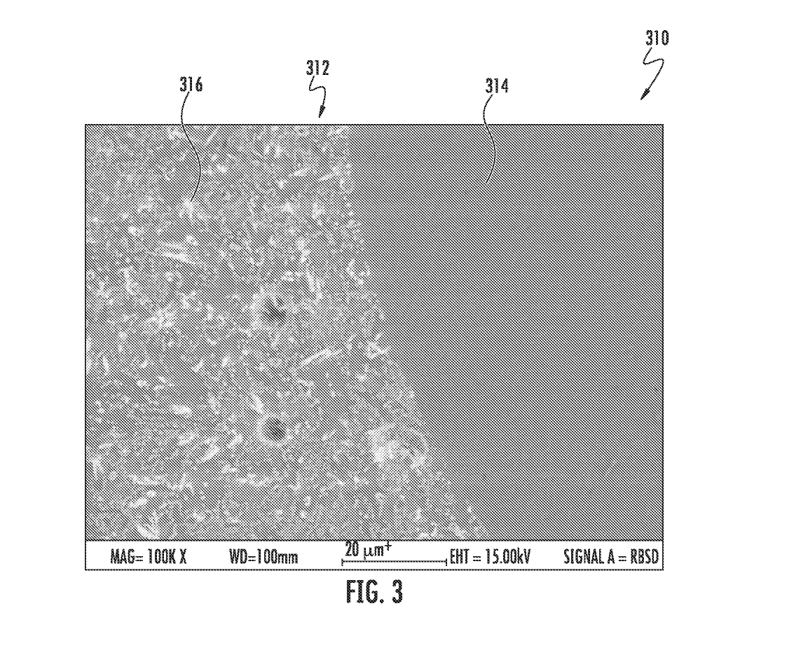

FIG. 3 shows the interface 312 of structure 310 between the silica 314 and the sintered Glass A plus glass-ceramic B 316. No de-vitrification was found at the silica interface 312 and no fracture was found in the matrix sintered glass. The bonding is very good. X-ray diffraction showed a pattern of the 50-50% Glass A and glass-ceramic B fired at 900° C. 2 hr. air, having several different crystalline phases, Virgilite, Gahnite, Willemite and Albite and glassy halos.

### Example 4

Referring to FIGS. 4-5, using the semi-analytic stress model, circumferential stresses in five-layer ferrules were calculated. Table I below shows values used in the stress model. Other than for the silica interior, the Poisson's ratio was estimated to be 0.3, and Young's elastic modulus and thermal expansion coefficient were treated as simple linear interpolations between the end members. Layer 1 (412) is silica, layer 2 (414) is a 50-50% mix of Glass A and glass-ceramic B, layer 3 (416) is 100% Glass A, layer 4 (418) is 25 volume % zirconia-3 mole % yttria plus 75 volume % Glass A, and layer 5 (420) is 50 volume % zirconia-3 mole % yttria plus 50 volume % Glass A.

TABLE I

| | Young's elastic | | Thermal | |
|---|---|---|---|---|
| Layer | modulus | | expansion/ | Layer outer radii |
| # | GPa | Poisson's ratio | ° C. | mm |
| 1 | 72.9 | 0.14 | 5.5 × 10⁻⁷ | 0.19 |
| 2 | 73 | 0.3 | 3.5 × 10⁻⁶ | 0.4 |
| 3 | 73 | 0.3 | 7 × 10⁻⁶ | 0.6 |
| 4 | 107 | 0.3 | 8.25 × 10⁻⁶ | 0.8 |
| 5 | 140 | 0.3 | 9.5 × 10⁻⁶ | 1.25 |

FIG. 4 shows the approximate circumferential stress distribution 410 through the layers 412, 414, 416, 418, 420, assuming the five-layer body was sintered at 800° C. and cooled to 0° C., with no stress relaxation. As can be seen from FIG. 4, the tensile stresses are moderately high at the interface 422 between the fourth and fifth layers 418, 420, almost 300 MPa, but are manageable for a fiber optic connector.

The semi-analytic stress model was again used for a second five-layer structure, where layer 1 (512) is silica, layer 2 (514) is 50-50% mix of Glass A and glass-ceramic B, layer 3 (516) is 100% Glass A, layer 4 (518) is 45 volume % zirconia-3 mole % yttria plus 55% Glass A, and layer 5 (520) is 90% zirconia-3 mole % yttria plus the remaining 10% being Glass A.

FIG. 5 shows the approximate circumferential stress distribution 510 through the layers 512, 514, 516, 518, 520, assuming the five-layer body was sintered at 800° C. and cooled to 0° C., with no stress relaxation. Table II below contains the relevant estimated properties. As can be seen, the stresses are higher than the first case (shown in FIG. 5) due to the larger thermal expansion difference and the higher elastic modulus. The highest tensile stress is at the interface 522 between the fourth and fifth layers 518, 520, about 550 MPa, but is still manageable for a fiber optic connector.

The stresses shown on the graph of FIG. 5 are approximant for several reasons. First, real-world interfaces are not mathematically sharp, there is a jumble of composition visible in the SEM micrographs along the interface between two compositions, which will smooth the sharp stress peaks somewhat. Secondly, the various composition layers are modeled as materials with uniform thermal expansion and elastic properties, which is not the case for the real-world materials having a combination of ceramic particles (agglomerates) and glass. The stresses in the glass near the ceramic particles and agglomerates is not uniform and the macro stresses are overlaid upon the micro-thermal expansion stresses.

TABLE II

| | Young's elastic | | Thermal | |
|---|---|---|---|---|
| Layer | modulus | | expansion/ | Layer outer radii |
| # | GPa | Poisson's ratio | ° C. | mm |
| 1 | 72.9 | 0.14 | 5.5 × 10⁻⁷ | 0.19 |
| 2 | 73 | 0.3 | 3.5 × 10⁻⁶ | 0.4 |
| 3 | 73 | 0.3 | 7 × 10⁻⁶ | 0.6 |
| 4 | 134 | 0.3 | 9.4 × 10⁻⁶ | 0.8 |
| 5 | 196 | 0.3 | 11.5 × 10⁻⁶ | 1.25 |

### Example I-z

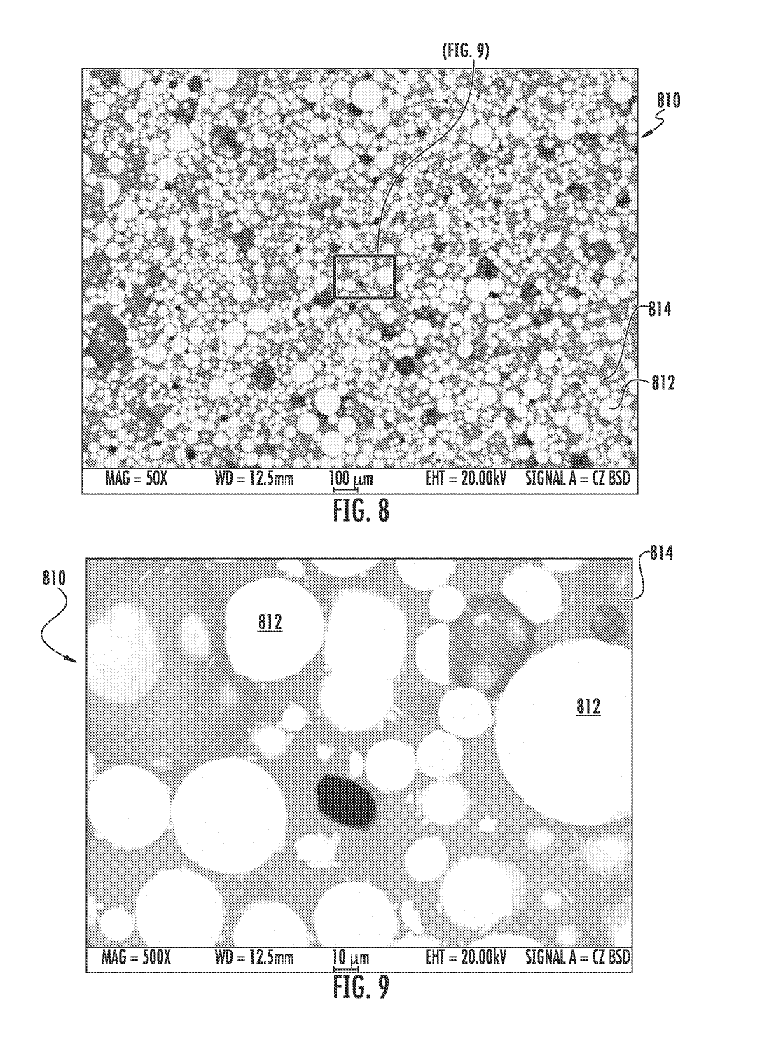

Referring to FIGS. 7-8, using the same semi-analytic stress model, the circumferential stresses in a 2-layer ferrule were calculated for comparison and contextual purposes. Table III below shows values entered into the stress model. The first layer 612 was assumed to be silica. Poisson's ratio was estimated to be 0.3 for the second layer 614, and the Young's elastic modulus and the thermal expansion coefficient are that of 100% zirconia-3 mole % yttria.

TABLE III

| | Young's elastic | | Thermal | |
|---|---|---|---|---|
| Layer | modulus | | expansion/ | Layer outer radii |
| # | GPa | Poisson's ratio | ° C. | mm |
| 1 | 72.9 | 0.14 | 5.5 × 10⁻⁷ | 1.15 |
| 2 | 210 | 0.3 | 12 × 10⁻⁶ | 1.25 |

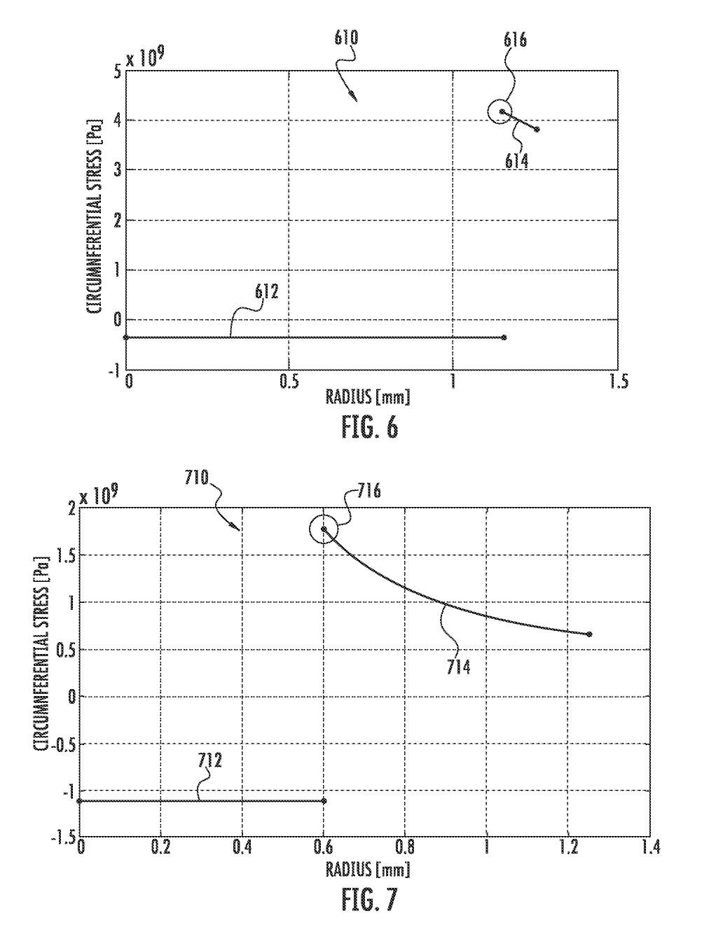

FIG. 6 shows the approximate circumferential stress distribution 610 through the layers 612, 614, assuming the 2-layer body was sintered at 1500° C. and cooled to 0° C., with no stress relaxation. As can be seen, the tensile stresses are extremely high at the interface 616 between the two layers 612, 616, greater than 4000 MPa, which may cause a composite ferrule to shatter.

### Example II-z

Using the semi-analytic stress model once again, circumferential stresses in a 2-layer ferrule were calculated. Table IV below shows values entered into the approximate stress model. The first layer 712 was assumed to be silica. The Poisson's ratio was estimated to be 0.3 for the second layer 714, and the Young's elastic modulus and the thermal expansion coefficient are that of 100% zirconia-3 mole % yttria. With this second two-layer model, instead of a thin coating, the zirconia outer layer 714 was substantially thicker.

FIG. 7 shows the approximate circumferential stress distribution 710, assuming the 2-layer body was sintered at 1500° C. and cooled to 0° C., with no stress relaxation. As can be seen, the tensile stresses are extremely high at the interface 716 between the two layers 712, 714, greater than about 1800 MPa and the compressive stress on the silica interior is very high, over 1000 MPa. A composite ferrule made this way may shatter.

TABLE IV

| | Young's elastic | | Thermal | |
|---|---|---|---|---|
| Layer | modulus | | expansion/ | Layer outer radii |
| # | GPa | Poisson's ratio | ° C. | mm |
| 1 | 72.9 | 0.14 | 5.5 × 10⁻⁷ | 0.6 |
| 2 | 210 | 0.3 | 12 × 10⁻⁶ | 1.25 |

### Example 5

Zirconia-3 mole % yttria pre-sintered agglomerates 812 were mixed with 37.5 volume % Glass A 814. The mixed powder was spread in a steel die and uni-axially pressed. The sample pre-form was placed in a latex iso-pressing bag, the air was removed by a vacuum pump, and the bag was sealed. The sample was cold iso-statically pressed to about 25 kpsi. The pressed sample was placed on coarse alumina “setter” sand in an alumina sagger box and sintered at 900° C. in air for 4 hours.

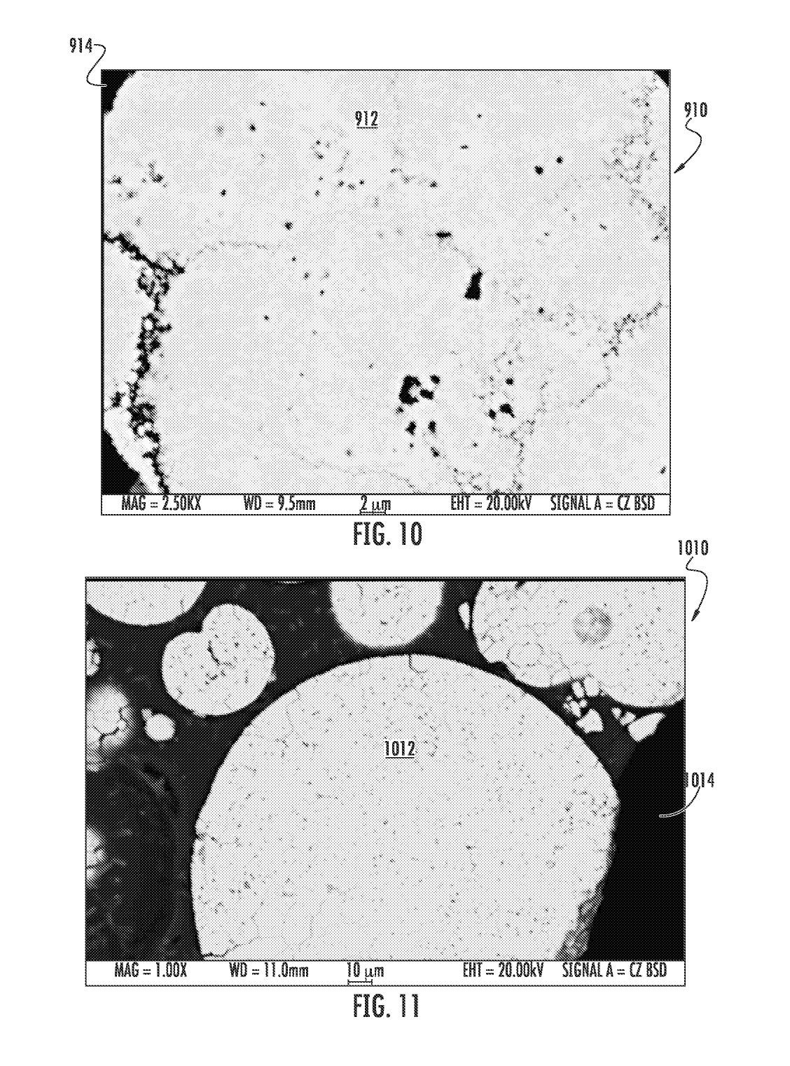

The sample 810 was cut, polished and examined by SEM. FIGS. 9-10 show the cross-section microstructure of 62.5% zirconia agglomerates plus 37.5% Glass A.

### Example 6

Commercial optical waveguide ferrules including zirconia may be toughened via phase transformation toughening. However, when materials for ferrule disclosed herein are sintered at temperatures below about 1250° C., the phases and grain size may not develop sufficiently to allow for transformation toughening. Furthermore, having significant glass as part of the ferrule composition can change the nano stresses at the grain boundary, which appear to play a role in nucleation of monoclinic zirconia under an external stress field.

To facilitate transformation toughening with materials disclosed herein, a survey of agglomerate pre-sintering temperatures and zirconia yttria dopant levels was performed. Zirconia compositions were used without pre-sintering or with pre-sintering of the agglomerates at 1300° C. to 1550° C. for two hours in air. The zirconia types tested included TZ0Y, zirconia without any dopant, TZ2Y, zirconia-2 mole % yttria, and TZ3Y, zirconia with 3 mole % yttria. The pre-sintered agglomerates were mixed with 50 volume % Glass A. The mixed powder was spread in a steel die and uni-axially pressed. The sample pre-form was placed in a latex iso-pressing bag, the air was removed by a vacuum pump, and the bag was sealed. The sample was cold iso-statically pressed to about 25 kpsi. The pressed sample was placed on coarse alumina “setter” sand in an alumina sagger box and sintered at about 800-900° C. in air for 4 hours. 2.5 cm square cross-section bars, about 6 inches in length, were pressed and sintered. The samples were machined into chevron notched short bar MC specimens and room temperature KIC measured. The samples were polished and examined by SEM and X-ray diffraction showed phases in the samples.

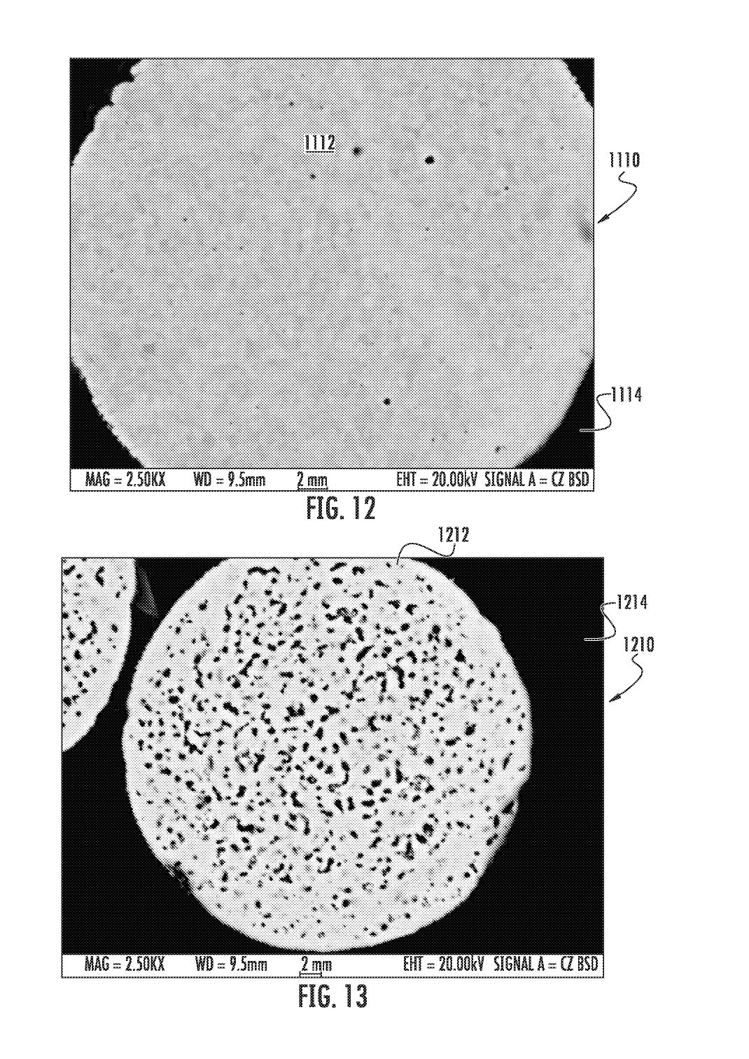

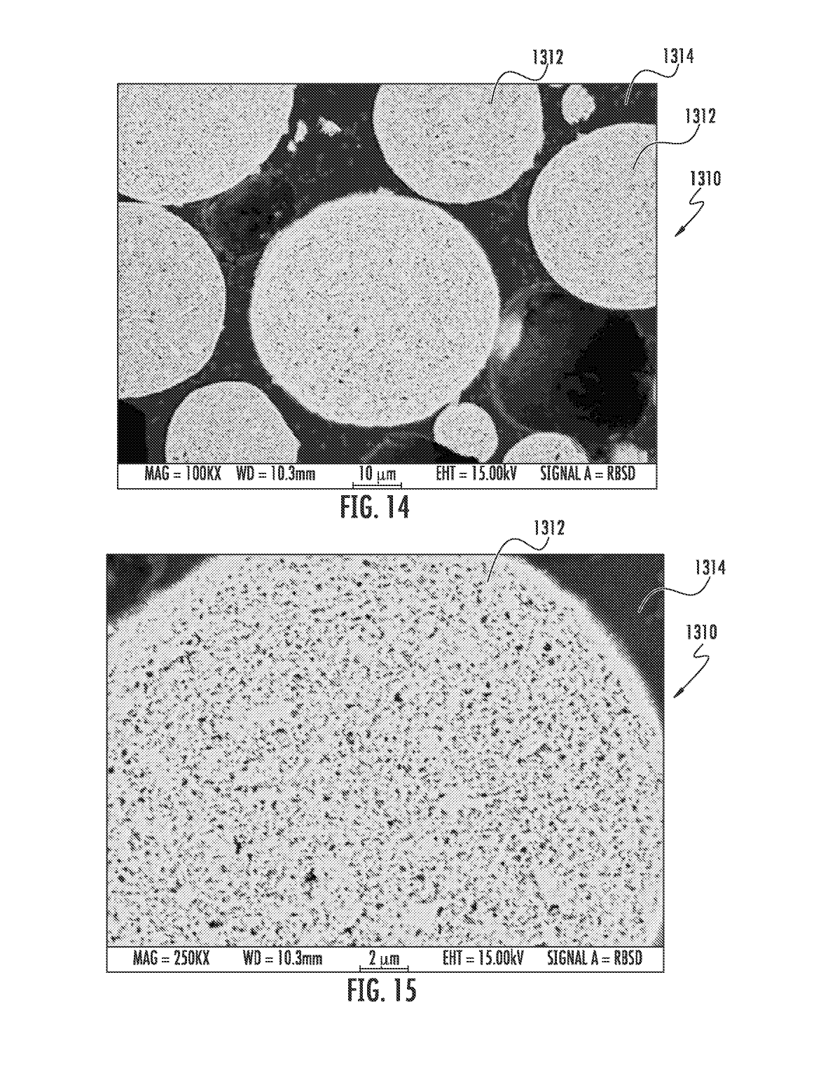

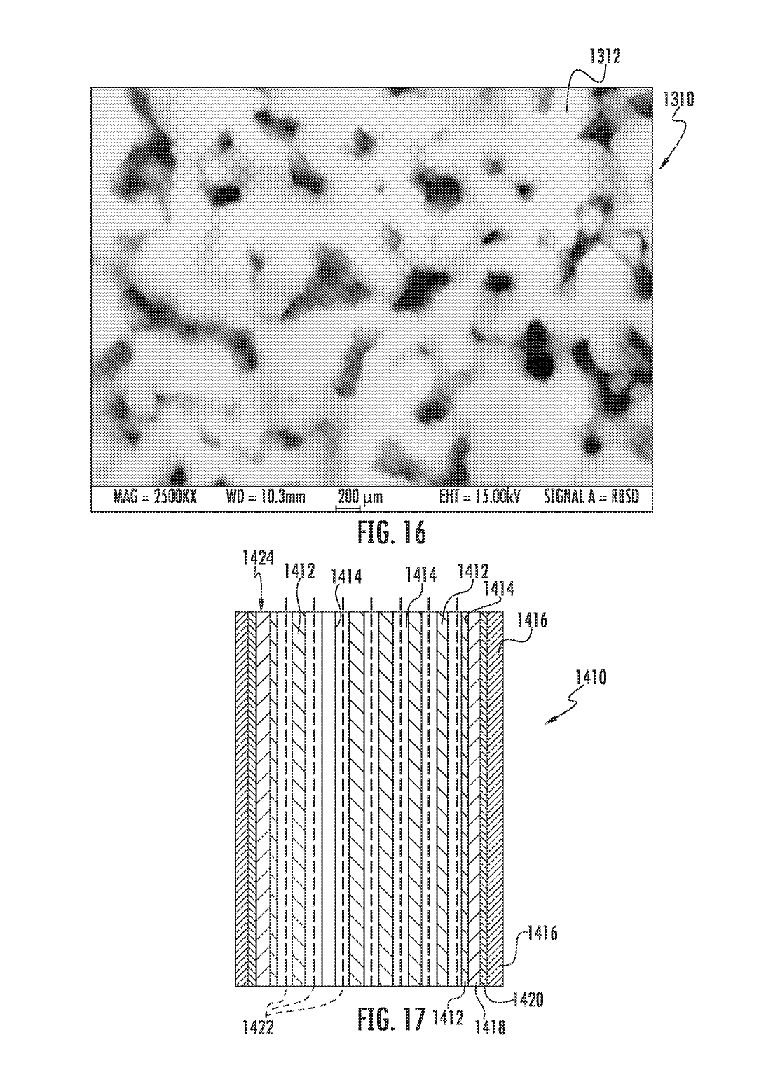

Table V below summarizes the testing, and FIGS. 10-16 show the results. FIG. 10 includes an SEM micrograph 910 of 2Y ZrO₂ (912) pre-sintered at 1500° C. in 50 volume % Glass A (914) sintered at 900° C. with MC about 1.8 MPa m″². FIG. 11 includes an SEM 1010 of 0Y ZrO₂ (1012) in 50% Glass A (1014) sintered 900° C. with MC about 1.3 MPa m^{1/2}. FIG. 12 includes an SEM 1110 of 3Y ZrO₂ (1112) pre-sintered at 1550° C. in 50% Glass A (1114) sintered 900° C. with KIC about 1.28 MPa M^{1/2}. FIG. 13 includes an SEM 1210 of 3Y ZrO₂ (1212) pre-sintered at 1400° C. in 50% Glass A (1214). FIGS. 14-16 include SEM 1310 of 3Y ZrO₂ (1312) pre-sintered at 1300° C. plus 50% Glass A (1314) sintered 900° C. with MC about 1.6 MPa m^{1/2}.

TABLE V

| | | | Zirconia | | | Fracture |
|---|---|---|---|---|---|---|
| | | | pre- | Sinter- | | tough- |
| | Yttria | | sinter | ing | | ness |
| | level in | | temper- | Temper- | Mono- | KIC |
| | Zirconia | Compo- | ature | ature | clinic | MPa |
| sample | Mole % | sition | ° C. | ° C. | level | (m)^{1/2} |
| alpha | 0 | | 1500 | 900 | high | 1.3 |
| beta | 2 | | 1500 | 900 | medium | 1.8 |
| gamma | 3 | | 1550 | 900 | low | 1.3 |
| delta | 3 | | 1400 | 900 | low | — |
| Eta | 3 | | 1300 | 900 | Very low | 1.6 |

Applicants found that agglomerates that were not pre-sintered, when sintered with 50 volume % Glass A at about 800-900° C. showed no sign of transformation toughening. Pre-sintered TZ0Y resulted in monoclinic zirconia and a fairly low KIC. Pre-sintered TZ3Y showed tetragonal zirconia with only a low amount of monoclinic in the x-ray pattern. TZ2Y pre sintered at 1500° C. showed a medium amount of monoclinic zirconia and an improved toughness, 1.8 MPa (m)^{1/2}. Accordingly, the preferred amount of yttria dopant in the zirconia is above 0 but 3 vol. % or lower for some such embodiments. As shown in FIGS. 14-16, the SEM micrographs 1310 show that sintering the loose agglomerates 1312 results in porous agglomerates 1312 at 1300° C. and 1400° C.

Referring now to FIG. 17, in some embodiments a multi-fiber ferrule 1410 is manufactured and used according to the above disclosure. Accordingly, in some such embodiments, the multi-fiber ferrule 1410 includes a low-expansion material 1412 (e.g., glass) coupled to an interior thereof and having a bore(s) 1414 defined therein, a higher-expansion material 1416 (e.g., zirconia) on the exterior of the ferrule 1410, and one or more graded transition layers 1418, 1420 therebetween, as disclosed herein. The interior 1412 may include more than one bore 1414 to receive multiple optical fibers 1422, where the low-expansion material 1412 forming each bore 1414 may be connected or separated into isolated bore-forming tubes, partitioned by the one or more transition layers.

As shown in FIG. 17, each bore 1414 supports an optical fiber 1422, where the bore 1414 is formed in a first material 1412 (e.g., glass, silica). The first material 1412 is surrounded by a second material 1418 (e.g., porous inorganic material), which is itself surrounded by a third material 1416 (e.g., typical zirconia ferrule materials). The second material 1418 may provide stress-isolation having higher porosity and/or lower elastic modulus relative to the first 1412 and third materials 1416, as further disclosed above with regard to other embodiments. In some embodiments, the ferrule 1410 includes additional intermediate layers 1418, 1420 between the bore 1414 and exterior 1416, which provided a graded transition with respect to coefficient of thermal expansion, modulus of elasticity, and/or other parameters, whereby stresses are disrupted and/or distributed to reduce peak stresses. The multi-fiber ferrule 1410 may support two, four, eight, twelve, sixteen, twenty-four, thirty-two, or other numbers of optical fibers 1422. In some embodiments, the multi-fiber ferrule 1410 is rectilinear, and the end face 1424 is generally rectangular.

The construction and arrangements of the ferrule systems and processes, as shown in the various exemplary embodiments, are illustrative only. Although only a few embodiments have been described in detail in this disclosure, many modifications are possible (e.g., variations in sizes, dimensions, structures, shapes, and proportions of the various elements, values of parameters, mounting arrangements, use of materials, colors, orientations) without materially departing from the novel teachings and advantages of the subject matter described herein. For example, the term “include,” and its variations, such as “including,” as used herein, in the alternative, means “comprising,” “primarily consisting of,” “consisting essentially of,” and/or “consisting of,” where possible in the particular usage herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present innovations and inventions.

What is claimed is:

1. A ferrule for optical waveguides, comprising:
an exterior of the ferrule;
an interior of the ferrule having a bore defined therein configured to receive an optical waveguide; and
material of the ferrule including one or more components, wherein the material of the ferrule is such that the material changes from the interior to the exterior of the ferrule wherein the thermal expansion coefficient transitions from less than 30×10⁻⁷/° C. at the interior of the ferrule to greater than 70×10⁻⁷/° C. at the exterior of the ferrule.

2. The ferrule of claim 1, wherein the thermal expansion coefficient of the material changes by way of discrete layers in the material between the interior and exterior of the ferrule.

3. The ferrule of claim 2, wherein the layers are graded such that each outwardly adjoining layer has a greater thermal expansion coefficient.

4. The ferrule of claim 3, wherein the ferrule comprises at least three discrete layers.

5. The ferrule of claim 1, wherein the thermal expansion coefficient transitions from less than 10×10⁻⁷/° C. at the interior to greater than 90×10⁻⁷/° C. at the exterior of the ferrule.

6. The ferrule of claim 1, wherein the material of the ferrule between the interior and exterior is at least partially porous.

7. The ferrule of claim 6, wherein the material of the ferrule between the interior and exterior has an average void fraction of at least 3%.

8. The ferrule of claim 6, wherein the material of the ferrule between the interior and exterior comprises porous agglomerates.

9. The ferrule of claim 8, wherein the interior comprises at least one of silica and a boro-silicate.

10. The ferrule of claim 9, wherein the exterior comprises zirconia.

11. A ferrule for optical waveguides, comprising:
an exterior of the ferrule;
an interior of the ferrule having a bore defined therein configured to receive an optical waveguide; and
material of the ferrule including one or more components, wherein the material of the ferrule is such that the material changes in thermal expansion coefficient from the interior to the exterior of the ferrule, wherein the material of the ferrule between the interior and exterior comprises has an average thermal expansion coefficient greater than the thermal expansion coefficient of the interior of the ferrule and less than the thermal expansion coefficient of the exterior of the ferrule.

12. The ferrule of claim 11, the material of the ferrule between the interior and exterior comprises discrete layers.

13. The ferrule of claim 12, wherein the layers are graded such that each outwardly adjoining layer has a greater thermal expansion coefficient.

14. The ferrule of claim 12, wherein the layers, in combination with each other, are at least 20 microns in thickness.

15. The ferrule of claim 11, wherein the material of the ferrule between the interior and exterior comprises a glass, and wherein the glass, in mole percentage, is at least one of:
59.08 SiO₂, 13.33 B₂O₃, 9.37 Al₂O₃, 8.03 Na₂O, 4.09 CaO, 1.28 Li₂O, 1.64 K₂O, 1.79 MgO, 1.37 ZrO₂.
60.0 SiO₂, 20.0 Al₂O₃, 20.0 ZnO.
59.0 SiO₂, 19.6 Al₂O₃, 12.4 ZnO, 6.8 Li₂O, 2.2 ZrO₂.

16. The ferrule of claim 11, the exterior of the ferrule further comprises a glass.

17. The ferrule of claim 16, the glass, in mole percentage, is 59.08 SiO₂, 13.33 B₂O₃, 9.37 Al₂O₃, 8.03 Na₂O, 4.09 CaO, 1.28 Li₂O, 1.64 K₂O, 1.79 MgO, 1.37 ZrO₂.

18. The ferrule of claim 11, wherein at least one of:
(i) the exterior of the ferrule consists of zirconia; and
(ii) the material of the ferrule between the interior and exterior comprises porous agglomerates, and the agglomerates mostly consists of zirconia.

19. The ferrule of claim 11, wherein the exterior of the ferrule comprises of zirconia and at least one of:
the zirconia mostly consists of tetragonal-phase zirconia;
the zirconia includes at least one of a rare-earth dopant, Y, Ca, Mg, In, Sc, TiO₂, SnO₂, Nb₂O₅, Ta₂O₅, WO₃, and MoO₃.

20. The ferrule of claim 11, wherein the exterior of the ferrule comprises of zirconia;
wherein the zirconia mostly consists of tetragonal-phase zirconia; wherein the zirconia includes at least one of a rare-earth dopant, Y, Ca, Mg, In, Sc, TiO₂, and SnO_{2;} and wherein the zirconia includes less than 3 mole-% yttria.
